(19) United States
(12) Patent Application Publication
(10) Pub. No.: US 2010/0240565 A1
(43) Pub. Date: Sep. 23, 2010

(54) Composition

(75) Inventors: Fabio CORRADINI, Mira (IT); Fabio D'AMICO, Mira (IT); Ralf WIEDEMANN, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/708,920

(22) Filed: Feb. 19, 2010

Related U.S. Application Data
(60) Provisional application No. 61/154,048, filed on Feb. 20, 2009.

(51) Int. Cl. C11D 3/42; C11D 3/395

(52) U.S. Cl. 510/276

(57) ABSTRACT

Disclosed is use of an aqueous composition comprising a bleach and an optical brightener as a pre-treatment composition in a laundry/fabric washing operation, as well as compositions and dispensing devices comprising the pre-treatment composition.

The present invention relates to an aqueous cleaning composition comprising an optical brightener and a bleach.

Optical brighteners are common ingredients in fabric/laundry washing or cleaning agents. They are used to prevent/disguise discoloration of items being cleaned. This discoloration is commonly exhibited as a yellowing/graying of the item being cleaned and is particularly prevalent in light/white colored items.

Optical brighteners operate by acting as a radiation absorber/emitter. Natural day light is adsorbed and then emitted with a blue-ish hue. This emitted light aids the overcoming of the discoloration issues.

It is an object of the present invention to provide an improved formulation comprising an optical brightener.

According to a first aspect of the present invention there is provided an aqueous composition comprising a bleach and an optical brightener.

According to a second aspect of the present invention there is provided the use of an aqueous composition comprising a bleach and an optical brightener as a pre-treatment composition in a laundry/fabric washing operation.

Surprisingly, it has been found that the composition and use of the present invention have improved performance in stain treatment when used in a fabric/laundry cleaning operation. Furthermore this is achieved whilst avoiding the problem of “white halos/spotting” which typically occurs with local applications of optical brighteners on items being cleaned resulting in areas of the item having a different shade of white. Without wishing to be bound by theory it is postulated that this enhanced performance arises due to the ability of the optical brightener to camouflage any remnants of the stain in the stain treatment step.

Preferably the optical brightener is present in an amount of 0.01 to 1 wt %, e.g. 0.08 wt %.

It is preferred that the optical brightener is selected from the substance class of 4,4′-diamino-2,2′-stilbenedisulfonic acids (flavonic acids), 4,4′-distyryl-biphenylene, methylumbelliferones, coumarins, dihydroquinolinones, 1,3-diaryl-pyrazolines, naphthalic acid imides, benzoxazole, benzisoxazole and benzimidazole systems as well as pyrene derivatives with heterocycle substituents.

Preferably the fabric treatment composition comprises a bleach. Where present the composition comprises from 0.001% to 99.99%, preferably 0.001% to 7%, preferably 2% to 6%, most preferably about 7%, by weight, of bleach. The bleach is preferably peroxide bleach, most preferably hydrogen peroxide. Peroxide sources other than H₂O₂ can be used.

Preferably the fabric treatment composition comprises a surfactant. Where present the composition comprises from 0.001% to 99.99%, preferably 0.05% to 15%, e.g. about 10%, by weight of surfactants.

The surfactant is, for example, an anionic or nonionic surfactant or mixture thereof. The nonionic surfactant is preferably a surfactant having a formula RO(CH₂CH₂O)ₙH wherein R is a mixture of linear, even carbon-number hydro-carbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂-₁₃ alkanol condensed with 6.5 moles ethylene oxide (Neodol 23-6.5), C₁₂-₁₃ alkanol with moles of ethylene oxide (Neodol 23-9), C12-15 alkanol condensed with 7 or 3 moles ethylene oxide (Neodol 25-7 or Neodol 25-3), C₁₄₋₁₅ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other examples of linear primary alcohol ethoxylates are available under the Lutensol trade name such as, for example, Lutensol A3N, a C₁₃₋₁₅ linear primary alcohol ethoxylate with 3 moles EO; Lutensol LA60, a C₁₃₋₁₅ linear primary alcohol ethoxylate with 7 moles EO. Also Genapol such as, for example, Genapol LA3, a C₁₃₋₁₅ linear primary alcohol ethoxylate with 3 moles EO; Genapol LA070, a C₁₃₋₁₅ linear primary alcohol ethoxylate with 7 moles EO

Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and acyl/oleoyl sarcosinates and mixtures thereof.

Preferably the fabric treatment composition comprises a solvent. Where present the composition comprises from 0% to 99.99% preferably from 0% to 10% by weight, of solvent.

The solvent constituent may comprise one or more alcohol, glycol, acetate, ether acetate or glycol ether. Exemplary alcohols useful in the compositions of the invention include C₂-C₈ primary and secondary alcohols which may be straight chained or branched, preferably pentanol and hexanol. More preferably the solvent is a glycol ether. Preferred examples of glycol ethers include glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

Specific and preferred solvents are selected from propylene glycol methyl ether, dipropylene glycol methyl ether, dipropylene glycol propyl ether, dipropylene glycol butyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

Most preferably the solvent or mixture of solvent is from the propanol series (Dowanol P-series) and among these Dipropylene Glycol n-Propyl Ether, Dipropylene Glycol n-Butyl Ether and Propylene Glycol Phenyl Ether. These are commercially available from Dow Chemicals as Dowanol DPnP, Dowanol DPnB and Dowanol PPH respectively.

Other useful solvents are hydrotropes such as sodium toluene sulfonate and sodium cumene sulfonate, short-chain alcohols such as ethanol and isopropanol, and the like. They can be present in the compositions as only solvents or in combination with other solvents.

Preferably the fabric treatment composition comprises a builder. Where present the composition comprises from 0% to 99.99% preferably from 0% to 10% by weight, of builder.

The fabric treatment composition may comprise minor amounts of various optional ingredients, including enzymes, dye transfer inhibition agents, dye catchers, preservatives, anti-static agents, fragrances, odour absorbing components.

The pH range of the fabric treatment composition is typically from about 3 to about 8, preferably about 3.5.

A most preferred composition is below:—

### Non Ionic Surfactant: 0.05% to 15%

### Anionic Surfactant: 0.05% to 5%

### IDS 30%: 1.0 wt %

### H₂O₂ 50%: 0.05% to 10%

Propylene glycol: 2.0 wt %

### Fragrance: 0.1-0.5 wt %

### Sulphuric Acid 93%: 0.1-0.5 wt %

### Optical Brightener: 0.1-1.0 wt %

### Water: Rest

pH 3.5, density 1.01 g/ml, Dry residue 9%

The composition is most preferably suitable for discharge application onto an item being cleaned using a spray device. Indeed in a preferred embodiment of the second aspect of the invention a spray device is employed. Such application typically occurs before the item is washed in an automatic washing machine, i.e. the composition is used as pre-treater. In this application it is most noticeable that the problem of white halos/spotting is avoided.

The spray device may comprise a propellant and thus be in the form of an aerosol type device, wherein the pressure of the propellant is used to aid the discharge of the contents of the spray device when the spray device is activated. Alternatively the spray device may be manually operated and thus be in the form of a trigger spray device. In these device application of pressure to an operating lever causes the operation of a pump which brings about dispense of the contents of the spray device.

The invention is now described with reference to the following non-limiting Examples.

### EXAMPLES

This testing followed the standard procedure for ASTM D 4265-83 (Revised Jan. 10, 1998), Standard Guide for Evaluating Stain Removal Performance in Home Laundering.

Products

| Raw Materials | Product A (wt %) | Product B (wt %) |
|---|---|---|
| Non Ionic Surfactant | 0.05-15 | 0.05-15 |
| Anionic Surfactant | 0.05-5 | 0.05-5 |
| IDS 30% | 1.0 | 1.0 |
| H₂O₂ 50% | 0.05-10 | 0.05-10 |
| Propylene glycol | 2.0 | 2.0 |
| Fragrance | 0.1-0.5 | 0.1-0.5 |
| Sulphuric Acid 93% | 0.1-0.5 | 0.1-0.5 |
| Optical Brightener | 0.1-1.0 | — |
| Water | Rest | Rest |

(A is in accordance with the invention, B is a comparative product)

### Washing

Once wash parameters were set to large load (86° F., 120 ppm, cold rinse, 4 lbs ballast) detergent was added and agitated for 30 seconds-1 minute. Ballast was added. Test cloths were set up on bench top. These were sprayed and rubbed for the stain pre-treatment. 2 ml of pre-treat product was applied to the stains on cloth; the product was rubbed 5 times backward and forward.

### Reading/Evaluation

The reflectance (L*a*b*) of residual stains was measured using the Datacolor 650 colorimeter (photoelectric colorimeter) or the equivalent with the UV filter. Background readings were taken on the white background that did not come into contact with stain or pre-treat material. All readings were taken after the washing and drying cycles are completed.

The results were statistically analysed using ANOVA general linear model with Tukey correction at 95% Confidence Level.

### Results

Composition A (in accordance with the invention) showed better cleaning than composition B (comparative). Composition A was found statistically superior than Formula B on stain removal of 5 out of 20 stains (with the remainder being parity performance).

1. A method of pretreating laundry/fabric comprising the step of: applying an aqueous pre-treatment composition comprising a bleach and an optical brightener to laundry/fabric in a laundry/fabric washing operation.

2. A method according to claim 1 wherein the aqueous pre-treatment composition is applied by spraying.

3. A method according to claim 1, wherein the optical brightener is present in the aqueous pre-treatment composition in an amount of 0.01 to 1 wt %.

4. A method according to claim 1, wherein the bleach is present is present in the aqueous pre-treatment composition in an amount of 0.01 to 10 wt %.

5. An applicator adapted for use in a laundry/fabric pre-treatment process which applicator comprises an aqueous pre-treatment composition comprising a bleach and an optical brightener.

6. An applicator according to claim 5 which is a spray device.

7. A method according to claim 5, wherein the optical brightener is present in the aqueous pre-treatment composition in an amount of 0.01 to 1 wt %.

8. A method according to claim 5, wherein the bleach is present is present in the aqueous pre-treatment composition in an amount of 0.01 to 10 wt %.

9. An applicator adapted for use in a laundry/fabric pretreatment process which applicator comprises an aqueous pre-treatment composition comprising an optical brightener.

10. An applicator according to claim 9 which is a spray device.

11. A method according to claim 9, wherein the optical brightener is present in the aqueous pre-treatment composition in an amount of 0.01 to 1 wt %.
